(19) United States
(12) Patent Application Publication
(10) Pub. No.: US 2013/0145910 A1
(43) Pub. Date: Jun. 13, 2013

(54) METHOD AND EQUIPMENT FOR MACHINING A HOLE IN METALLIC MEMBER

(71) Applicants: YU-TING LIN, Tu-Cheng (TW); JING-HUA YUAN, Shenzhen City (CN)

(72) Inventors: YU-TING LIN, Tu-Cheng (TW); JING-HUA YUAN, Shenzhen City (CN)

(21) Appl. No.: 13/653,617

(22) Filed: Oct. 17, 2012

(30) Foreign Application Priority Data
Dec. 7, 2011 (CN) 201110403315.7

(51) Int. Cl. B26D 7/02

(52) U.S. Cl. 83/14; 83/451

(57) ABSTRACT

A method for machining a hole in a metallic member includes the following steps: providing a metallic member and a machining equipment, the metallic member includes a machining portion, and the machining equipment includes a first support member, a second support member, a cutter, and a fixing member; placing the first and second support members on two sides of the metallic member covering the machining portion, and then placing the metallic member and the first and second support members on the fixing member; machining at least one through hole in the machining portion and the first and second support members by the cutter; and removing the first and second support members machined to obtain the metallic member having the at least one through hole.

### BACKGROUND

1. Technical Field

The present disclosure generally relates to methods and equipment for machining hole, and particularly to a method for machining hole in a metallic member.

2. Description of Related Art

Housings of many electronic devices are made of metal. A plurality of small holes is usually machined in the metal housing. However, burrs may occur in a periphery of the small holes, which are difficult to remove, thus affecting an aesthetic appearance and a touch feeling. Additionally, the housings are usually curved, so it is difficult to machine holes with a same size and a same shape in different positions of the housing which also negatively affects the aesthetic appearance.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 shows a flowchart of a method for machining a hole in a metallic member of a first embodiment.

FIG. 2 shows an isometric view of an original metallic member to be machined by the method for machining a hole in a metallic member of the first embodiment or of the second embodiment.

FIG. 3 shows an assembled, isometric view of an equipment used in the method for machining a hole in a metallic member of the first embodiment, on which the original metallic member of FIG. 2 is placed.

FIG. 4 shows an exploded, isometric view of the equipment of FIG. 3 with the original metallic member of FIG. 2.

FIG. 5 shows a flowchart of a method for machining a hole in a metallic member of a second embodiment.

FIG. 6 shows an assembled, isometric view of an equipment used in the method for machining a hole in a metallic member of the second embodiment, on which an original metallic member of the second embodiment is placed.

FIG. 7 is similar as FIG. 6, but shows a hole has been machined in one of the predetermined machining portions of the metallic member.

### DETAILED DESCRIPTION

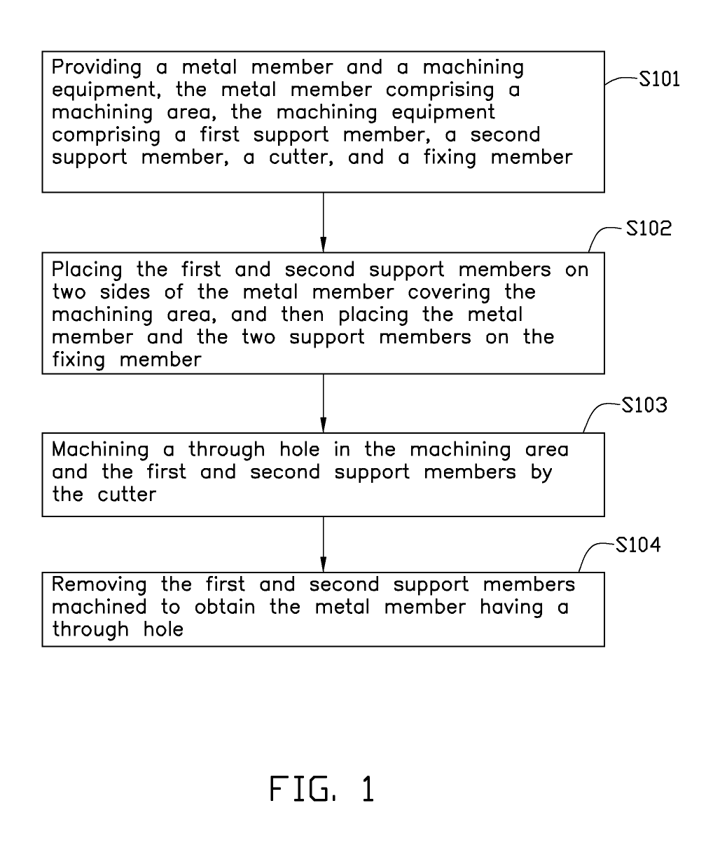

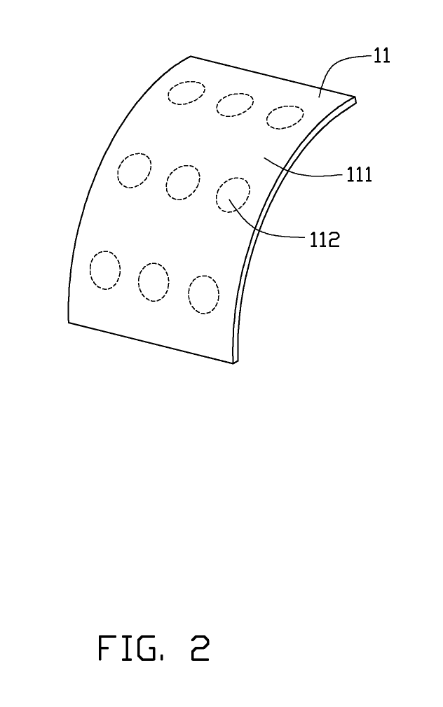

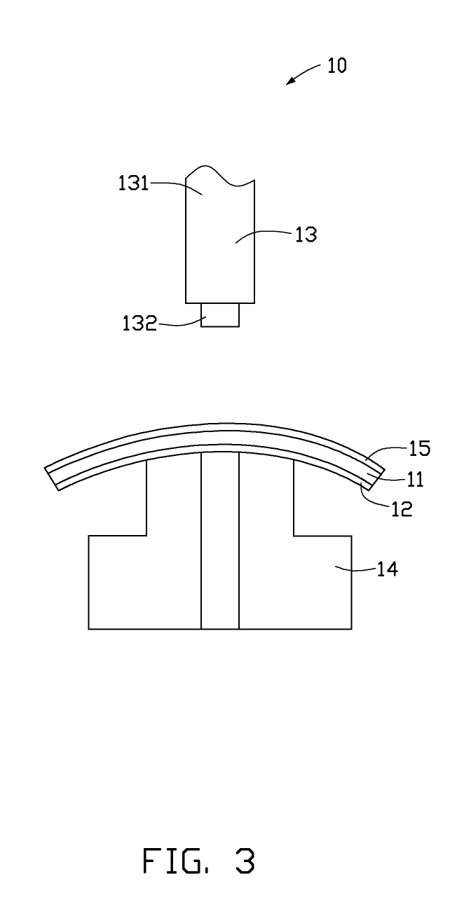

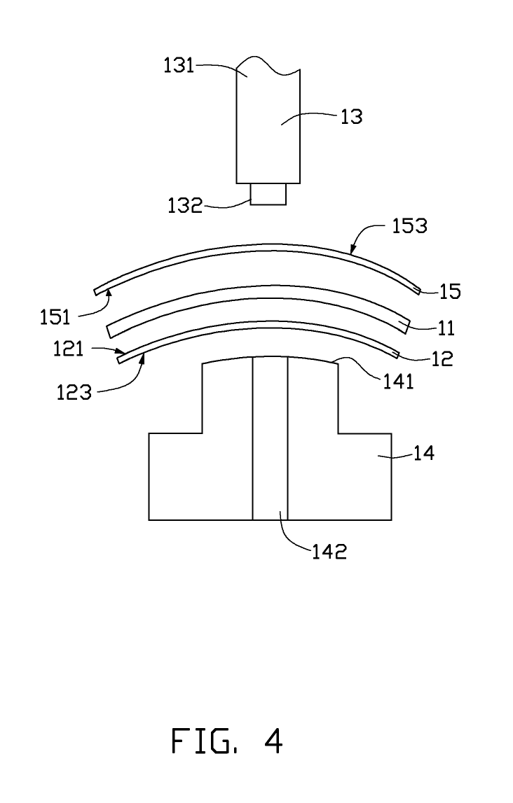

Referring to FIGS. 1 through 4, a first embodiment of a method for machining a hole in a metallic member is illustrated as follows.

In step S101, a metallic member 11 and machining equipment 10 are provided. The metallic member 11 includes a machining surface 111. The machining surface 111 includes a plurality of machining portions 112 arranged in a line. In the illustrated embodiment, the machining surface 111 is arcuate, and each of the machining portions 112 is substantially circular. In other embodiments, the machining surface 111 of the metallic member 11 is not arcuate, and can be planar, or other irregular curved pieces. The machining portions 112 can be square or other shapes.

The machining equipment 10 includes a first support member 12, a second support member 15 opposite to the first support member 12, a cutter 13 placed above the first and second support members 12, 15, and a fixing member 14. The metallic member 11 is sandwiched between the first and second support members 12, 15. The first and second support members 12, 15 installed with the metallic member 11 are placed on the fixing member 14. The first support member 12 is away from the cutter 13. The second support member 15 is adjacent to the cutter 14. The first support member 12 includes a first resisting surface 121 resisted against the metallic member 11 and a first outer surface 123 opposite to the first resisting surface 121 and away from the metallic member 11. The first resisting surface 121 points to outside the curvature. The first outer surface 123 points to inside the curvature. The first resisting surface 121 and the first outer surface 123 have a similar shape to the machining surface 111. A curvature of the first resisting surface 121 and the first outer surface 123 is substantially the same as that of the machining surface 111. A thickness of the first support member 12 is equal to or smaller than that of the metallic member 11. The first support member 12 is made of metal or plastic. The second support member 15 has a similar shape to the first support member 12. However, the second resisting surface 151 points to inside the curvature. The second outer surface 153 points to outside the curvature. A thickness of the second support member 15 is equal to or smaller than that of the metallic member 11. The second support member 15 is made of metal or plastic. In the illustrated embodiment, the first support member 12 is made of plastic, and the second support member 15 is made of metal.

The cutter 13 includes a cutter bracket 131 and a cutter head 132 fixed to the cutter bracket 131. The cutter 13 can be a punch cutter, a drilling cutter, or a milling cutter. In the illustrated embodiment, the cutter 13 is a punch cutter, and the cutter bracket 131 is a hollow cylinder.

The fixing member 14 has a structure in accordance with the cutter 13. In the illustrated embodiment, the fixing member 14 is a stepped platform, and includes a fixing surface 141. A curvature of the fixing surface 141 is substantially the same as that of the first outer surface 123, such that when the first support member 12 is placed on the fixing member 14, the whole of the first outer surface 123 is supported on the fixing surface 141. A through hole 142 is defined in the fixing surface 141, matched with the cutter 13. In other embodiments, the fixing member 14 may have other structures to match with the cutter 13. For example, when the cutter 13 is a drilling cutter, the fixing member 14 is configured as a grasper, and opposite ends of the metallic member 11 and the first and second support members 12, 15 are securely grasped by the fixing member 14.

In step S102, the first and second support members 12, 15 are respectively placed on two sides of the metallic member 11, and cover the machining portion 112. And then, the metallic member 11 and the first and second support members 12, 15 are placed on the fixing member 14, and one of the machining portions 112 is opposite to the cutter 13.

In step S103, a through hole is machined in one of the machining portions 112 of the metallic member 11 and the first and second support members 12, 15 by the cutter 13. In the illustrated embodiment, the second support member 15 is marked in positions according to the machining portions 112, to facilitate the cutter 13 positioning during machining.

In step S104, the first and second support members 12, 15 machined are removed to obtain the metallic member 11 having the through hole without burrs.

After machining, the first and second support members 12, 15 and the metallic member 11 are unloaded from the fixing member 14, and then the metallic member 11 is separated from the first and second support members 12, 15, because the first and second support members 12, 15 abut against two sides of the metallic member 11 covering the machining portion 112, and the first and second support members 12, 15 are made of metal or plastic, such that burrs caused by machining occur in peripheries of through holes in the first and second support members 12, 15, preventing burrs from occurring in peripheries of through holes in the metallic member 11. Thus, an aesthetic appearance of the metallic member 11 is fine.

When another metallic member 11 is required to be machined, another first and second support members 12, 15 are provided, and the above-mentioned steps are repeated to continuously machine through holes in the metallic member 11.

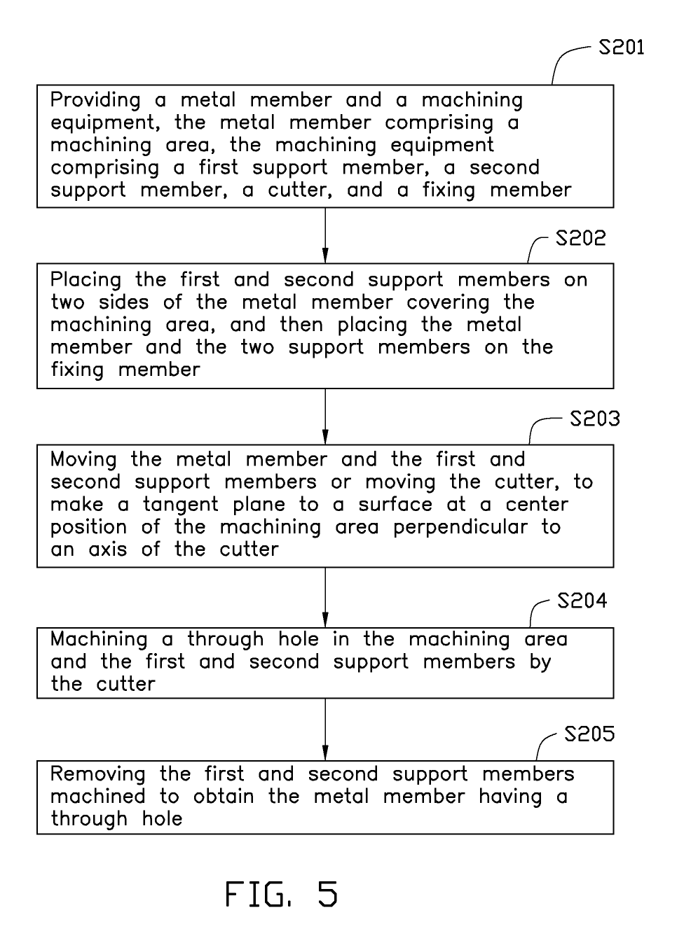

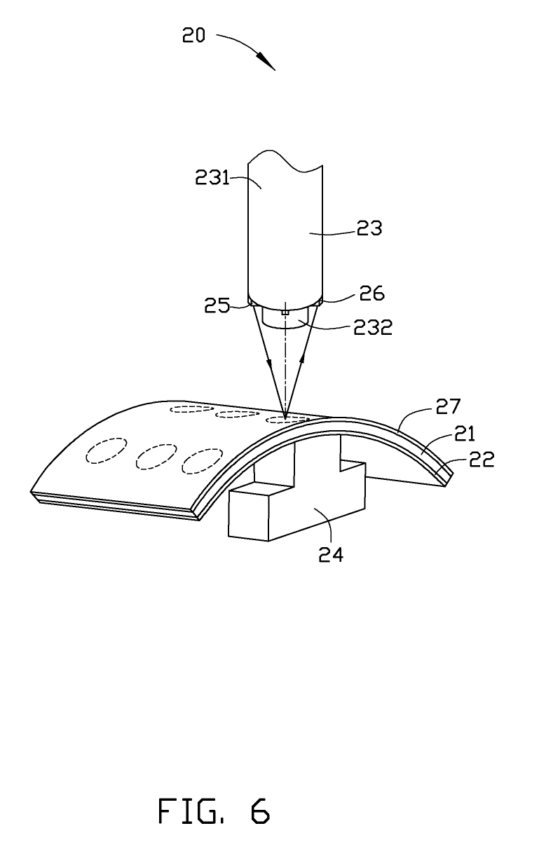

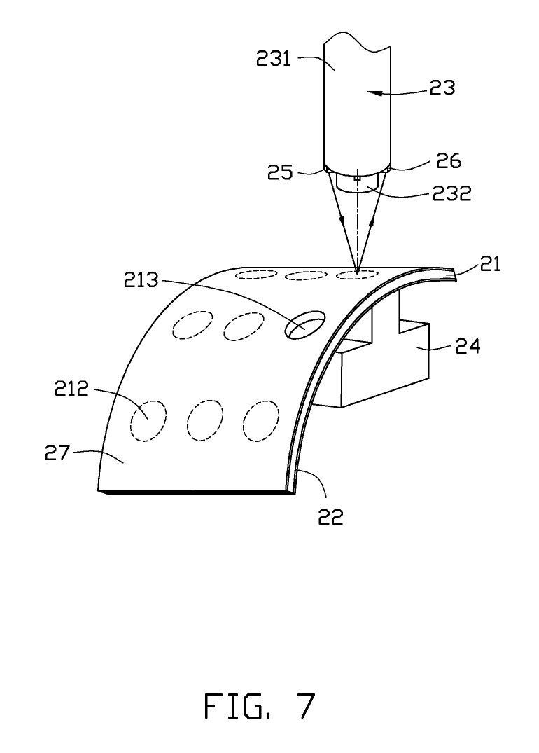

Referring to FIGS. 5 through 7, a second embodiment of a method for a hole machining in a metallic member includes steps of S201, S202, S203, S204, and S205.

In step S201, a metallic member 21, and a machining equipment 20 are provided. The metallic member 21 is substantially the same as the metallic member 11 of the first embodiment. The machining equipment 20 is similar as the machining equipment 10 of the first embodiment. However, the machining equipment 20 further includes two light sets consisting of light emitters 25 and light sensors 26. The two light sets of light emitters 25 and light sensors 26 are symmetrically placed on an end surface of a cutter bracket 231 around a cutter head 232. In other embodiments, the number of the light sets can be changed as needed, such as one, three, or more.

Step S202 is substantially the same as step S102 of the first embodiment.

In step S203, the metallic member 21 and the first and second support members 22, 27 are moved relatively to the cutter 23, to make a tangent plane to a surface at a center position of the machining portion 212 perpendicular to an axis of the cutter 23.

Step S204 is substantially the same as step S103 of the first embodiment. Step S205 is substantially the same as step S104 of the first embodiment.

In the second embodiment, the first and second support members 22, 27 abut against two sides of the metallic member 21, and the metallic member 21 and the first and second support members 22, 27 are movably placed on the fixing member 24.

When the cutter 23 is placed above the fixing member 24, the light emitters 25 emit light toward the second support member 27, according to the center of the machining portion 212. When the tangent plane to the surface at the center position of the machining portion 212 is perpendicular to the axis of the cutter 23, the light is reflected to the light sensors 26, and then a through hole 213 is machined in the metallic member 21. When the tangent plane to the surface at the center position of the machining portion 212 is slanted to the axis of the cutter 23, a position of the metallic member 21 and the second support member 27 relative to the fixing member 24 is adjusted until the tangent plane is perpendicular to the axis of the cutter 23, and then a through hole 213 is machined in the metallic member 23.

After machining one of the machining portions 212, the metallic member 21 and the first and second support members 22, 27 are moved to make a tangent plane to a surface at a center position of another machining portion 212 perpendicular to the axis of the cutter 23, such that a plurality of machining portions 212 are machined respectively to obtain the metallic member 21 having a plurality of circle through holes 123. Because in each hole machining process, the axis of the cutter 23 is perpendicular to the tangent plane to the surface at the center position of the machining portion 212, an axis of the through hole 213 machined in the metallic member 21 overlaps with a normal at the center position of the machining portion 212. Thus, sizes and shapes of through holes 213 machined in the metallic member 21 are the same, and the metallic member 21 has a better aesthetic appearance.

In other embodiments, the metallic member 21 and the first and second support members 22, 27 can be securely placed on the fixing member 24, and the fixing member 24 can be moveable relatively to the cutter 23. In an alternative embodiment, the metallic member 21, the first and second support members 22, 27, and the fixing member 24 cannot be moveable, and the cutter 23 is moveable relatively to the metallic member 22 to make the axis of the cutter 23 perpendicular to the tangent plane to the surface at the center position of the machining portion 212.

Depending on the embodiment, certain of the steps described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is to be understood, however, that even through numerous characteristics and advantages of the disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A method for machining a hole in a metallic member, the method comprising:
providing a metallic member and a machining equipment, the metallic member comprising a machining portion, the machining equipment comprising a first support member and a second support member, a cutter, and a fixing member;
placing the first and second support members on two sides of the metallic member covering the machining portion, and then placing the first and second support members installed with the metallic member on the fixing member;
machining a through hole in the machining portion of the metallic member with the first and second support members by the cutter; and
removing the first and second support members to obtain the metallic member having a through hole.

2. The method of claim 1, wherein the metallic member comprises a machining surface, the first support member comprises a first resisting surface resisting against the metallic member, the second support member comprises a second resisting surface resisting against the metallic member, the machining surface, and the first and second resisting surfaces are curved, and a curvature of the first and second resisting surfaces is substantially the same as a curvature of the machining surface.

3. The method of claim 2, wherein a thickness of the first and second support members is equal to or smaller than a thickness of the metallic member.

4. The method of claim 1, wherein the first and second support members are made of metal or plastic.

5. The method of claim 4, wherein the first support member is away from the cutter, the second support member is adjacent to the cutter, the first support member is made of plastic, and the second support member is made of metal.

6. The method of claim 1, wherein the cutter is a punch cutter.

7. The method of claim 6, wherein the fixing member comprises a fixing surface, the first support members comprises a first outer surface opposite to the first resisting surface and away from the metallic member, and a curvature of the fixing surface is substantially the same as the curvature of the first outer surface.

8. The method of claim 1, wherein the cutter is a drilling cutter or milling cutter.

9. A method for machining a hole in a metallic member, the method comprising:
providing a metallic member and a machining equipment, the metallic member comprising a machining portion, the machining equipment comprising a first support member, a second support member, a cutter, and a fixing member;
placing the first and second support members on two sides of the metallic member covering the machining portion, and then placing the first and second support members installed with the metallic member on the fixing member;
moving the metallic member and the first and second support members or moving the cutter, to make a tangent plane to a surface at a center position of the machining portion perpendicular to an axis of the cutter;
machining a through hole in the machining portion and the first and second support members by the cutter; and
removing the first and second support members to obtain the metallic member having a through hole.

10. The method of claim 9, wherein the machining equipment further comprises a light set consisting of a light emitter and a light sensor, and the light set tests whether the tangent plane to the surface at the center position of the machining portion is perpendicular to an axis of the cutter.

11. The method of claim 10, wherein the cutter comprises a cutter bracket and a cutter head fixed to the cutter bracket, and the light set is placed on en end surface of the cutter bracket around the cutter head.

12. The method of claim 9, wherein the machining equipment further comprises another light set.

13. The method of claim 9, wherein the metallic member comprises a machining surface, the first support member comprises a first resisting surface resisting against the metallic member, the second support member comprises a second resisting surface resisting against the metallic member, the machining surface, and the first and second resisting surfaces are curved, and a curvature of the first and second resisting surfaces is substantially the same as a curvature of the machining surface.

14. The method of claim 9, wherein a thickness of the first and second support member is equal to or smaller than a thickness of the metallic member.

15. The method of claim 9, wherein the first and second support member is made of metal or plastic.

16. The method of claim 15, wherein the first support member is away from the cutter, the second support member is adjacent to the cutter, the first support member is made of plastic, and the second support member is made of metal.

17. The method of claim 9, wherein the cutter is a punch cutter.

18. The method of claim 17, wherein the fixing member comprises a fixing surface, the first support members comprises a first outer surface opposite to the first resisting surface and away from the metallic member, and a curvature of the fixing surface is substantially the same as the curvature of the first outer surface.

19. An equipment for machining a hole in a metallic member, the equipment comprising a first support member, a second support member, a cutter placed above the first and second support members, and a fixing member, wherein the metallic member is sandwiched between the first and second support members, and the metallic member and the first and second support members are placed on the fixing member.

20. The equipment of claim 19, wherein the equipment further comprises a light set placed on the cutter, and the light set consists of a light emitter and a light sensor.
